(19) United States
(12) Patent Application Publication
(10) Pub. No.: US 2017/0127439 A1
(43) Pub. Date: May 4, 2017

(54) Collision Handling in Multi-Subscription Wireless Communication Devices

(71) Applicant: QUALCOMM Incorporated, San Diego, CA (US)

(72) Inventors: Thawatt Gopal, San Diego, CA (US); Reza Shahidi, San Diego, CA (US); Shiau-He Tsai, San Diego, CA (US)

(21) Appl. No.: 14/927,286

(22) Filed: Oct. 29, 2015

(51) Int. Cl. H04W 72/12; H04B 17/30; H04W 52/02; H04B 1/3816; H04M 15/00

(52) U.S. Cl. CPC H04W 72/1263; H04B 1/3816; H04M 15/7556; H04W 52/0235; H04B 17/30

(57) ABSTRACT

Various embodiments may include methods for handling collisions between a first subscription and a second subscription of a wireless communication device. In various embodiments, a processor of the wireless communication device may determine whether there are persistent collisions between periodic paging wake-ups on the first subscription and periodic inter-RAT measurements on the second subscription. When persistent collisions are detected, the time for performing each inter-RAT measurement on the second subscription may be extended sufficient to enable completing inter-RAT measurements on the second subscription. The amount by which the time for performing inter-RAT measurements is extended may depend upon the timing and duration of the persistent collisions.

### BACKGROUND

Some designs of wireless communication devices—such as smart phones, tablet computers, and laptop computers—contain one or more Subscriber Identity Module (SIM) cards that provide users with access to multiple separate mobile telephony networks. Examples of mobile telephony networks include Third Generation (3G), Fourth Generation (4G), Long Term Evolution (LTE), Time Division Multiple Access (TDMA), Frequency Division Multiple Access (FDMA), Code Division Multiple Access (CDMA), Wideband CDMA (WCDMA), Time Division Synchronous CDMA (TD-SCDMA), Global System for Mobile Communications (GSM), and Universal Mobile Telecommunications Systems (UMTS).

A wireless communication device that includes one or more SIMs and connects to two or more separate mobile telephony networks supporting two or more subscriptions using one or more shared radio frequency (RF) resources/radios may be termed a multi-subscription, multi-standby (MSMS) communication device. One example of an MSMS device is a dual-SIM dual-standby (DSDS) communication device, which includes two SIM cards supporting two or more subscriptions that are each associated with a separate radio access technology (RAT). In DSDS communication devices, the separate subscriptions share one RF resource chain to communicate with two separate mobile telephony networks on behalf of their respective subscriptions. When one subscription is using the RF resource, the other subscription is in stand-by mode and is not able to communicate using the RF resource.

One consequence of wireless communication devices configured to support a plurality of SIMs/subscriptions that maintain network connections simultaneously is that the subscriptions may sometimes interfere with each other's communications. For example, two subscriptions on a DSDS communication device utilize a shared RF resource to communicate with their respective mobile telephony networks, and only one subscription may use the RF resource to communicate with its mobile network at a time. Even when one or more subscriptions are in “idle-standby” mode, meaning that the subscriptions are not actively communicating with the network, the subscriptions may still need to periodically receive access to the shared RF resource in order to perform various network operations. For example, subscriptions may periodically perform a paging indicator channel (PICH) wake-up to check whether any paging messages have been received from its associated network. Certain subscriptions, for example TD-SCDMA, may periodically perform a dedicated channel (DCH) measurement occasion (DMO) gap in connected mode. The DMO gap may involve performing neighbor cell inter-RAT measurements to determine whether a handover to another cell and/or another RAT is possible. For example, a TD-SCDMA subscription may perform DMO gaps to determine whether a handover to a LTE cell is possible.

The respective networks of each subscription may determine the periodicity and duration of the idle mode activities. For example, the paging (e.g., PICH) wake-ups of one subscription may occur with a certain periodicity while the inter-RAT measurements (e.g., DMO gaps) of another subscription may occur with another periodicity. If the timing of the activities overlap and the periods are the same, then the paging wake-up activities of one subscription may persistently collide with the inter-RAT measurements of the other subscription. Because paging wake-ups take precedence over inter-RAT measurements, the inter-RAT measurements may continually be interrupted. This prevents the subscription that is performing the inter-RAT measurements from identifying other RATs for a handover, which may impact the user experience.

### SUMMARY

Various embodiments include methods implemented on a wireless communication device for handling collisions between a first subscription and a second subscription of the wireless communication device. Various embodiments may include determining whether there are persistent collisions between periodic paging wake-ups on the first subscription and periodic inter-RAT measurements on the second subscription, and extending a time for performing each inter-RAT measurement on the second subscription in response to determining that there are persistent collisions between periodic paging wake-ups on the first subscription and periodic inter-RAT measurements on the second subscription.

In some embodiments, determining whether there are persistent collisions between periodic paging wake-ups on the first subscription and periodic inter-RAT measurements on the second subscription may include monitoring inter-RAT measurement attempts on the second subscription for a predetermined time period. The predetermined time period may be a number of inter-RAT measurement periods.

In some embodiments, extending the time for performing each inter-RAT measurement on the second subscription may include determining whether the paging wake-ups begin before the inter-RAT measurements, and extending an end of each inter-RAT measurement by an overlap time between the inter-RAT measurements and the paging wake-ups in response to determining that the paging wake-ups begin before the inter-RAT measurements. In some embodiments, extending the time for performing each inter-RAT measurement on the second subscription may include determining whether the paging wake-ups end before the inter-RAT measurements end and extending the beginning of each inter-RAT measurement by an overlap time between the inter-RAT measurements and the paging wake-ups in response to determining that the paging wake-ups do not end before the inter-RAT measurements end.

In some embodiments, extending the time for performing each inter-RAT measurement on the second subscription may include determining whether the paging wake-ups end before the inter-RAT measurements end, and in response to determining that the paging wake-ups end before the inter-RAT measurements end, determining a first non-overlapping time period between the beginning of the inter-RAT measurements and the beginning of the paging wake-ups, determining a second non-overlapping time period between an end of the paging wake-ups and an end of the inter-RAT measurements, and determining whether the first non-overlapping time period is greater than the second non-overlapping time period. Some embodiments may further include extending the beginning of each inter-RAT measurement by a time equal to an network allocated time to perform each inter-RAT measurement minus the first non-overlapping time period in response to determining that the first non-overlapping time period is greater than the second non-overlapping time period, and extending the end of each inter-RAT measurement by a time equal to the network allocated time to perform each inter-RAT measurement minus the second non-overlapping time period in response to determining that the first non-overlapping time period is not greater than the second non-overlapping time period.

Some embodiments may further include determining whether there has been a change in periodicity of the paging wake-ups or a change in periodicity of the inter-RAT measurements, and determining whether there are persistent collisions between the periodic paging wake-ups on the first subscription and the periodic inter-RAT measurements on the second subscription in response to determining that there has been a change in the periodicity of the paging wake-ups or a change in the periodicity of the inter-RAT measurements.

Further embodiments include a wireless communication device including a memory and a processor configured with processor-executable instructions to perform operations of the methods described above. Further embodiments include a non-transitory processor-readable storage medium having stored thereon processor-executable software instructions configured to cause a processor of a wireless communication device to perform operations of the methods described above. Further embodiments include a wireless communication device that includes means for performing functions of the methods described above.

### BRIEF DESCRIPTION OF THE DRAWINGS

The accompanying drawings, which are incorporated herein and constitute part of this specification, illustrate exemplary aspects of various embodiments, and together with the general description and the detailed description given herein, serve to explain the features of the embodiments.

FIG. 1 is a communication system block diagram of a network suitable for use with various embodiments.

FIG. 2 is a block diagram illustrating a wireless communication device according to various embodiments.

FIG. 3 is a timing diagram illustrating persistent collisions that may occur between subscriptions on a wireless communication device according to various embodiments.

FIGS. 4A-4B are timing diagrams illustrating an example of extending an inter-RAT measurement to compensate for persistent collisions between subscriptions on a wireless communication device according to various embodiments.

FIGS. 5A-5B are timing diagrams illustrating another example of extending an inter-RAT measurement to compensate for persistent collisions between subscriptions on a wireless communication device according to various embodiments.

FIGS. 6A-6B are timing diagrams illustrating a further example of extending an inter-RAT measurement to compensate for persistent collisions between subscriptions on a wireless communication device according to various embodiments.

FIG. 7 is a process flow diagram illustrating a method of handling persistent collisions between subscriptions on a wireless communication device according to various embodiments.

FIG. 8 is a process flow diagram illustrating a method of extending the time for performing inter-RAT measurement in the presence of paging wake-up interruptions on a wireless communication device according to various embodiments.

FIG. 9 is a component diagram of an example wireless communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the embodiments or the claims.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless communication device on a network and enable a communication service with the network. Because the information stored in a SIM enables the wireless communication device to establish a communication link for a particular communication service or services with a particular network, the term “SIM” is also be used herein as a shorthand reference to the communication service associated with and enabled by the information stored in a particular SIM as the SIM and the communication network, as well as the services and subscriptions supported by that network, correlate to one another. Similarly, the term SIM may also be used as a shorthand reference to the protocol stack and/or modem stack and communication processes used in establishing and conducting communication services with subscriptions and networks enabled by the information stored in a particular SIM.

As used herein, the terms “wireless communication device,” “multi-SIM communication device” and “multi-SIM wireless communication device” are used interchangeably to describe a wireless communication device that is configured to receive more than one SIM and support multiple subscriptions associated with the multiple SIMs.

The terms “network,” “wireless network,” “cellular network,” and “cellular wireless communication network” are used interchangeably herein to refer to a portion or all of a wireless network of a carrier associated with a wireless communication device and/or subscription on a wireless communication device.

In the following descriptions of various embodiments, references are made to a first subscription and a second subscription. The references to the first and second subscriptions are arbitrary and are used merely for the purposes of describing the embodiments. The device processor may assign any indicator, name, or other designation to differentiate the subscriptions on the mobile communication device.

In the following descriptions of various embodiments, references are made to specific RATs associated with specific SIMs/subscriptions, such LTE, TD-SCDMA, WCDMA, CDMA, or GSM subscriptions. The references to LTE, TD-SCDMA, WCDMA, CDMA, or GSM are arbitrary and used merely for the purposes of describing the embodiments. SIMs/subscriptions in various embodiments may utilize a variety of RATs to communicate with a mobile telephony network, including but not limited to 3G, 4G, LTE, TDMA, CDMA, WCDMA, GSM, and UMTS.

Modern wireless communication devices (e.g., smartphones) may be configured to accept multiple SIM cards containing SIMs that enable the same wireless communication device to connect to different mobile networks. Each SIM serves to identify and authenticate a subscriber using a particular wireless communication device, and each SIM is typically associated with only one subscription. For example, a SIM may be associated with a subscription to one of LTE, GSM, CDMA, TD-SCDMA, or WCDMA.

An MSMS wireless communication device, for example a DSDS device, may include multiple SIMs associated with multiple subscriptions that share an RF resource. The RF resource may include one or more receivers, transmitters, and/or transceivers and one or more antennas. When one subscription is active and utilizing the RF resource, the other subscriptions remain idle but may occasionally interrupt the active subscription to perform certain idle mode operations. Examples of such idle mode operations include paging (e.g., PICH) wake-ups and inter-RAT measurements (e.g., DMO gaps). Even when all subscriptions are idle, each subscription may periodically perform these idle mode functions using the shared RF resource.

A first subscription, for example a GSM, CDMA, or WCDMA subscription, may periodically perform paging wake-ups according to a period and with a duration that may be set by the network base station on which the first subscription is camped. A second subscription, for example a TD-SCDMA subscription, may periodically perform inter-RAT measurements according to another period and with a different duration that may be set by the network base station on which the second subscription is camped. For example, the inter-RAT measurements may be used to determine whether there are any LTE or other 4G network cells available for a handover on the second subscription.

If the period of the paging wake-ups of the first subscription overlaps with the period of the inter-RAT measurements of the second subscription, then the paging wake-up activities of the first subscription may persistently collide with the inter-RAT measurements of the second subscription. Paging wake-ups usually have a higher priority than inter-RAT measurements. Consequently, under some conditions the inter-RAT measurements performed by the second subscription may be interrupted persistently and therefore unable to be completed. As a result, the second subscription may not be able to initiate a handover even though a higher data rate RAT is available. This may impact the user experience on the wireless communication device.

Systems, methods, and devices of various embodiments enable a wireless communication device to handle persistent collisions between a first subscription and a second subscription to enable inter-RAT measurements to be conducted. A processor of the wireless communication device may determine whether there are persistent collisions between periodic paging wake-ups on the first subscription and periodic inter-RAT measurements on the second subscription. For example, the processor may monitor inter-RAT measurement attempts on the second subscription for a predetermined time period, such as a certain number of periods of the inter-RAT measurement. The processor may determine whether there are persistent collisions every time there is a change in periodicity of either the paging wake-up or inter-RAT measurement (e.g., one subscription camps on another cell, which may change the length of a period or the relative timing of periods).

In response to determining that persistent collisions exist between the paging wake-ups and the inter-RAT measurements, the processor may extend the time for performing each inter-RAT measurement on the second subscription to compensate for the interruption caused by the paging wake-ups.

The manner in which in which the time for performing inter-RAT measurements is adjusted may depend upon the timing of the persistent collisions. If the paging wake-ups begin before the inter-RAT measurements, the processor may extend the end of each inter-RAT measurement by an overlap time between the inter-RAT measurements and the paging wake-ups. If the inter-RAT measurements begin before the paging wake-ups and the paging wake-ups do not end before the inter-RAT measurements end, the processor may extend the beginning of each inter-RAT measurement by an overlap time between the inter-RAT measurements and the paging wake-ups.

The amount by which the time for performing inter-RAT measurements is extended may also depend upon the timing and duration of the persistent collisions. If the inter-RAT measurements begin before the paging wake-ups and the paging wake-ups end before the inter-RAT measurements end (i.e., the paging wake-ups occur entirely within the span of the inter-RAT measurements), the processor may determine a first non-overlapping time period between the beginning of the inter-RAT measurements and the beginning of the paging wake-up and a second non-overlapping time period between the end of the paging wake-ups and the end of the inter-RAT measurements. The processor may determine whether the first non-overlapping time period is greater than the second non-overlapping time period. If the first non-overlapping time period is greater, the processor may extend the beginning of each inter-RAT measurement by a time equal to an network allocated time to perform each inter-RAT measurement minus the first non-overlapping time period. If the second non-overlapping time period is greater or equal to the first non-overlapping time period, the processor may extend the end of each inter-RAT measurement by a time equal to an network allocated time to perform each inter-RAT measurement minus the second non-overlapping time period.

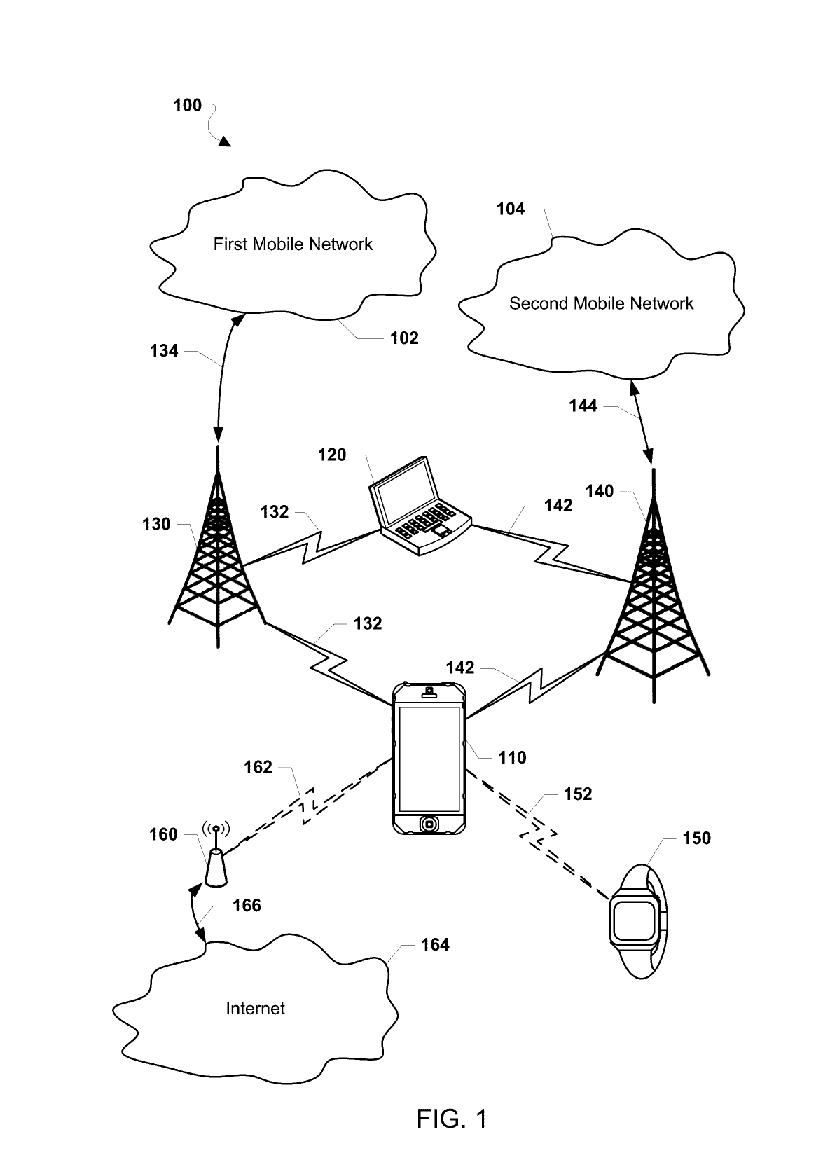

Various embodiments may be implemented within a variety of communication systems 100, such as at least two mobile telephony networks, an example of which is illustrated in FIG. 1. A first mobile network 102 and a second mobile network 104 typically each include a plurality of cellular base stations (e.g., a first base station 130 and a second base station 140). A first wireless communication device 110 may be in communication with the first mobile network 102 through a cellular connection 132 to the first base station 130. The first wireless communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second wireless communication device 120 may similarly communicate with the first mobile network 102 through the cellular connection 132 to the first base station 130. The second wireless communication device 120 may also communicate with the second mobile network 104 through the cellular connection 142 to the second base station 140. The cellular connections 132 and 142 may be made through two-way wireless communication links, such as Third Generation (3G), Fourth Generation (4G), Long Term Evolution (LTE), Time Division Multiple Access (TDMA), Code Division Multiple Access (CDMA), Wideband CDMA (WCDMA), Global System for Mobile Communications (GSM), Universal Mobile Telecommunications Systems (UMTS), and other mobile telephony communication technologies.

While the wireless communication devices 110, 120 are shown connected to the first mobile network 102 and, optionally, to the second mobile network 104, in some embodiments (not shown), the wireless communication devices 110, 120 may include two or more subscriptions to two or more mobile networks and may connect to those subscriptions in a manner similar to those described herein.

In some embodiments, the first wireless communication device 110 may optionally establish a wireless connection 152 with a peripheral device 150 used in connection with the first wireless communication device 110. For example, the first wireless communication device 110 may communicate over a Bluetooth® link with a Bluetooth-enabled personal computing device (e.g., a “smart watch”). In some embodiments, the first wireless communication device 110 may optionally establish a wireless connection 162 with a wireless access point 160, such as over a Wi-Fi connection. The wireless access point 160 may be configured to connect to the Internet 164 or another network over a wired connection 166.

While not illustrated, the second wireless communication device 120 may similarly be configured to connect with the peripheral device 150 and/or the wireless access point 160 over wireless links.

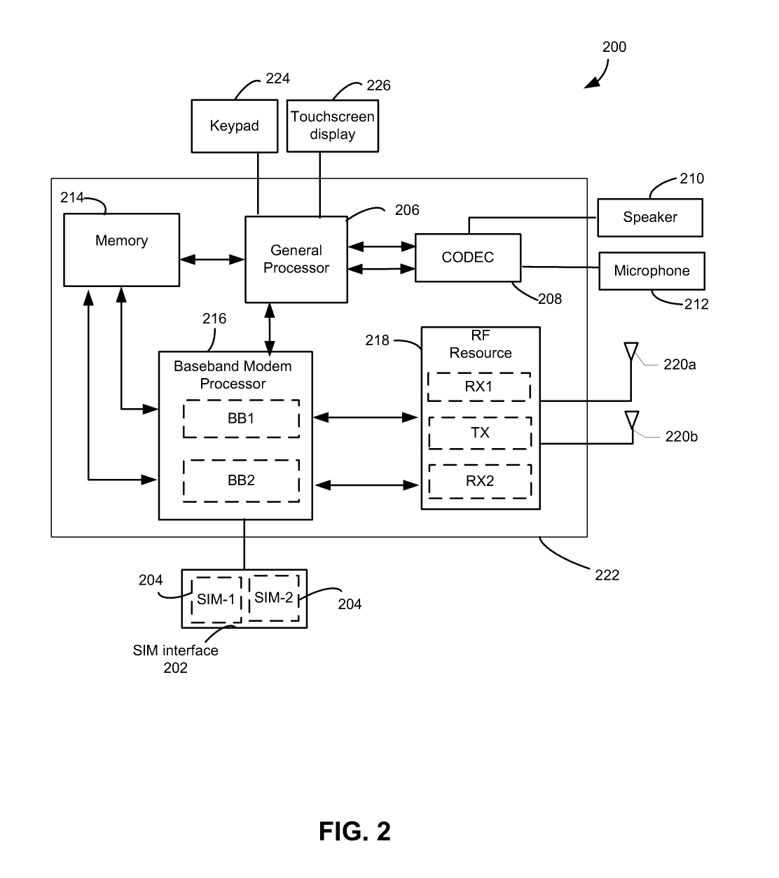

FIG. 2 is a functional block diagram of an example multi-SIM communication device 200 that is suitable for implementing various embodiments. With reference to FIGS. 1-2, the multi-SIM communication device 200 may be similar to one or more of the wireless communication devices 102. The multi-SIM communication device 200 may include a SIM interface 202, which may represent either one or two SIM interfaces. The SIM interface 202 may receive a first identity module SIM 204 that is associated with the first subscription. In some embodiments, the multi-SIM communication device 200 may also include a second SIM interface as part of the SIM interface 202, which may receive a second identity module SIM 204 that is associated with a second subscription.

A SIM in various embodiments may be a Universal Integrated Circuit Card (UICC) that is configured with SIM and/or Universal SIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204 may have a central processing unit (CPU), read only memory (ROM), random access memory (RAM), electrically erasable programmable read only memory (EEPROM) and input/output (I/O) circuits. A SIM 204 used in various embodiments may contain user account information, an IMSI a set of SIM application toolkit (SAT) commands and storage space for phone book contacts. A SIM 204 may further store home identifiers (e.g., a System Identification Number (SID)/Network Identification Number (NID) pair, a Home Public Land Mobile Number (HPLMN) code, etc.) to indicate the SIM network operator provider. An Integrated Circuit Card Identity (ICCID) SIM serial number may be printed on the SIM card for identification.

The multi-SIM communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to the first or second subscription though a corresponding baseband-RF resource chain. The memory 214 may store operating system (OS), as well as user application software and executable instructions. The memory 214 may also store quality metrics for various channels supported by the SIMs 204 and the RF resource 218.

The general purpose processor 206 and memory 214 may each be coupled to at least one baseband-modem processor 216. Each SIM 204 in the multi-SIM communication device 200 may be associated with a baseband-RF resource chain that includes a baseband-modem processor 216 and at least one receive block (e.g., RX1, RX2) of an RF resource 218. In various embodiments, baseband-RF resource chains may include physically or logically separate baseband modem processors (e.g., BB1, BB2).

The RF resource 218 may be coupled to antennas 220a, 220b, and may perform transmit/receive functions for the wireless services associated with each SIM 204 of the multi-SIM communication device 200. In some embodiments, the RF resource 218 may be coupled to wireless antennas 220a, 220b for sending and receiving RF signals for multiple SIMs 204 thereby enabling the multi-SIM communication device 200 to perform simultaneous communications with separate networks and/or service associated with the SIM(s) 204. The RF resource 218 may include separate receive and transmit functionalities, or the RF resource 218 may include a transceiver that combines transmitter and receiver functions. In various embodiments, the transmit functionalities of the RF resource 218 may be implemented by at least one transmit block (TX), which may represent circuitry associated with one or more radio access technologies/SIMs

In some embodiments, the general purpose processor 206, memory 214, baseband-modem processor(s) 216, and RF resource 218 may be included in a system-on-chip device 222. The one or more SIM 204 and corresponding interface(s) 202 may be external to the system-on-chip device 222. Further, various input and output devices may be coupled to components of the system-on-chip device 222, such as interfaces or controllers. Example user input components suitable for use in the multi-SIM communication device 200 may include, but are not limited to, a keypad 224 and a touch screen display 226.

In some embodiments, the keypad 224, touch screen display 226, microphone 212, or a combination thereof, may perform the function of receiving the request to initiate an outgoing call. For example, the touch screen display 226 may receive a selection of a contact from a contact list or receive a telephone number. In another example, either or both of the touch screen display 226 and microphone 212 may perform the function of receiving a request to initiate an outgoing call. For example, the touch screen display 226 may receive selection of a contact from a contact list or receive a telephone number. As another example, the request to initiate the outgoing call may be in the form of a voice command received via the microphone 212. Interfaces may be provided between the various software modules and functions in the multi-SIM communication device 200 to enable communication between them, as is known in the art.

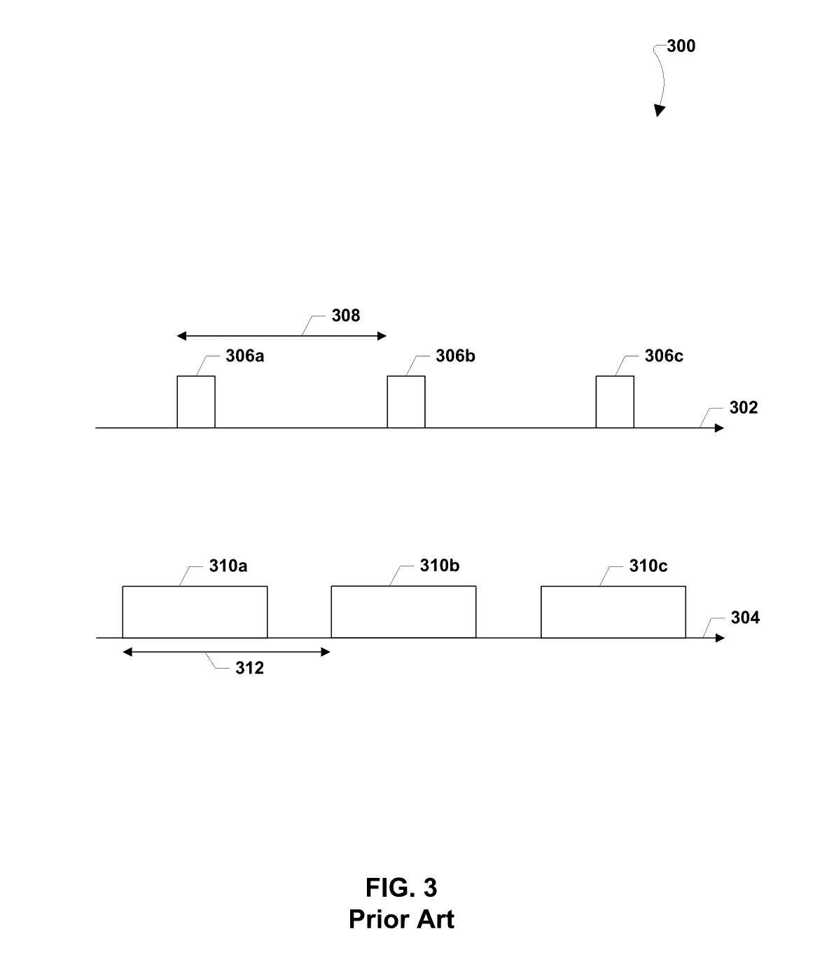

FIG. 3 includes a timing diagram 300 illustrating persistent collisions between paging wake-ups on a first subscription 302 and inter-RAT measurements on a second subscription 302 in a MSMS wireless communication device. With reference to FIGS. 1-3, a first subscription 302 when idle may perform periodic paging (e.g., PICH) wake-ups 306a, 306b, and 306c according to a period 308. The period 308 may be set by the network base station on which the first subscription 302 is currently camped. For example, the first subscription 302 may be utilizing a WCDMA RAT, and the network base station sets the period 308 to be 640 milliseconds (ms). The duration of each paging wake-up 306a-306c may also be determined by the network base station, for example a duration of 17 ms.

A second subscription 304, when idle, may perform periodic inter-RAT measurements 310a, 310b, and 310c according to a period 312. The period 312 may be set by the network base station on which the second subscription 304 is currently camped. For example, the second subscription 304 may be utilizing a TD-SCDMA RAT, and the network base station sets the period 312 to be 640 ms. The duration of each inter-RAT measurement 310a-310c may also be determined by the network base station, for example a duration of 40 ms.

When the periods 308, 312 are the same, there is a chance that the paging wake-ups 306a-306c may persistently collide (i.e., continually overlap over successive periods) with the inter-RAT measurements 310a-310c, as illustrated in the timing diagram 300. Generally, paging wake-ups take precedence over inter-RAT measurements and thus the second subscription 304 would have to give control of the shared RF resource to the first subscription 302 so that the first subscription 302 may perform the paging wake-ups 306a-306c. This leaves the second subscription 304 with less time to complete the inter-RAT measurements 310a-310c, which may mean that the inter-RAT measurements 310a-310c cannot be fully completed on each successive attempt. For example, if the inter-RAT measurements 310a-310c were attempted to search for a higher data rate RAT for a handover, the handover may not be completed unless the length or relative timing of the periods 308, 312 change to allow for completion of the inter-RAT measurements 310a-310c (e.g., the first subscription 302 or the second subscription 304 camps on another cell).

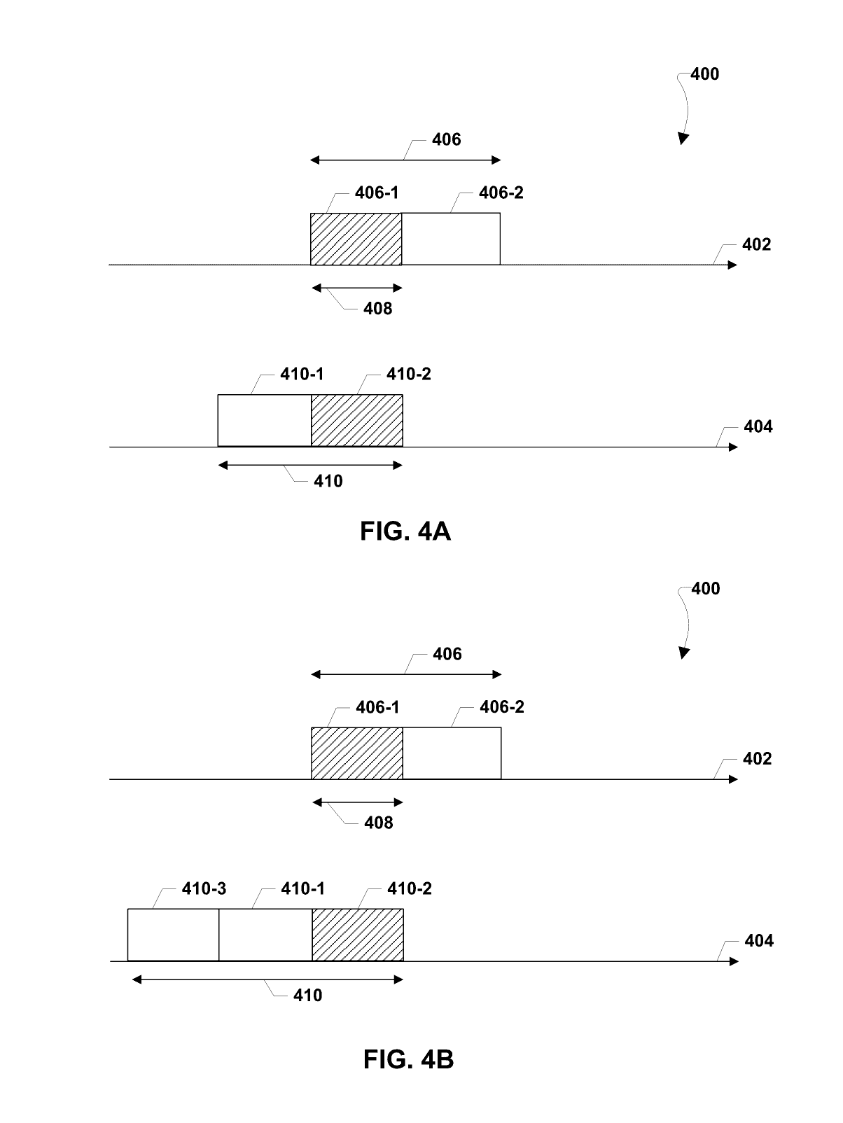

The network may set the duration of the inter-RAT measurements 310a-310c. However, the wireless communication device is free to internally change the duration of the inter-RAT measurements 310a-310c independently from the network. In various embodiments, when persistent collisions are detected, the wireless communication device may extend the time to perform each inter-RAT measurement to compensate for the time that is lost because of the paging wake-up interruption. The extension of time may be based on the relative timing of the inter-RAT measurement compared to the paging wake-up. Various examples of extending the duration of an inter-RAT measurement based on relative timing with an interrupting paging wake-up are illustrated in FIGS. 4A-6B.

FIG. 4A includes a timing diagram 400 that illustrates a collision between a paging wake-up 406 on a first subscription 402 and an inter-RAT measurement 410 on a second subscription 404 of an MSMS wireless communication device. With reference to FIGS. 1-4B, the paging wake-up 406 may be divided into two portions; a first paging wake-up portion 406-1, and a second paging wake-up portion 406-2. Likewise, the inter-RAT measurement 410 may be divided into a first inter-RAT measurement portion 410-1 and a second inter-RAT measurement portion 410-2. In the example illustrated in FIG. 4A, the inter-RAT measurement 410 begins before the paging wake-up 406 begins, and ends before the end of the paging wake-up 406. In this example, the first paging wake-up portion 406-1 overlaps with the second inter-RAT measurement portion 410-2 by a certain overlap time 408. During the overlap time 408, the shared RF resource of the wireless communication device may tune to the first subscription 402 and perform the paging wake-up 406, which means that the second inter-RAT measurement portion 410-2 is interrupted and not performed.

To compensate for the time lost due to the paging wake-up 406, the wireless communication device may extend the beginning of the inter-RAT measurement 410 by a third inter-RAT measurement portion 410-3 as illustrated in FIG. 4B. The time duration of the third inter-RAT measurement portion 410-3 may be (at least) equal to the overlap time 408 (i.e., the same time duration as the second inter-RAT measurement portion 410-2 that was interrupted). For example, if the network allocated duration of the inter-RAT measurement 410 is 40 ms, and the paging wake-up 406 overlaps with the inter-RAT measurement 410 by 10 ms (i.e., the overlap time 408 is 10 ms), the time duration of the third inter-RAT measurement portion 410-3 added to the beginning of the inter-RAT measurement 410 may be 10 ms. The sum of the time duration of the third inter-RAT measurement portion 410-3 (i.e., the overlap time 408) and the first inter-RAT measurement portion 410-1 may equal the network allocated duration of 40 ms. This gives the second subscription 404 enough time to complete the inter-RAT measurement 410 even though the measurement is interrupted by the paging wake-up 406.

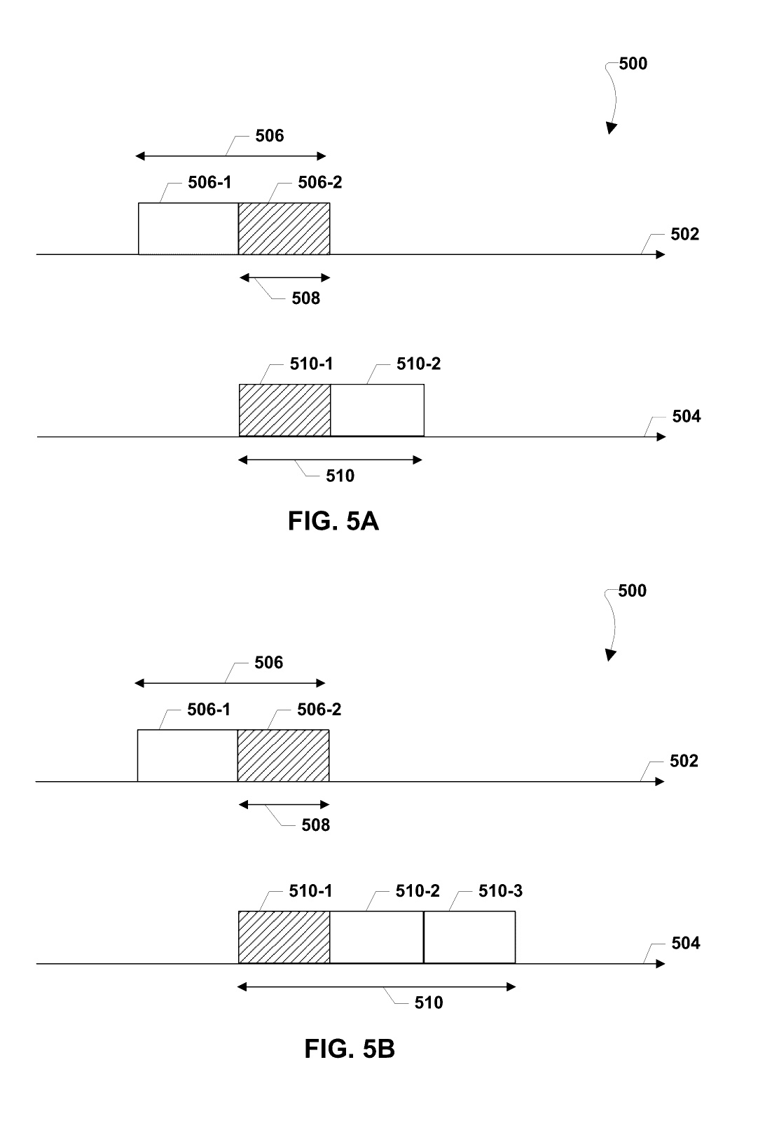

FIG. 5A includes a timing diagram 500 that illustrates a collision between a paging wake-up 506 on a first subscription 502 and an inter-RAT measurement 510 on a second subscription 504 of an MSMS wireless communication device. With reference to FIGS. 1-5B, the paging wake-up 506 may be divided into two portions; a first paging wake-up portion 506-1, and a second paging wake-up portion 506-2. Likewise, the inter-RAT measurement 510 may be divided into a first inter-RAT measurement portion 510-1 and a second inter-RAT measurement portion 510-2. In the example illustrated in FIG. 5A, the inter-RAT measurement 510 begins after the paging wake-up 506 begins and ends after the paging wake-up 506 ends. In this example, the second paging wake-up portion 506-2 overlaps with the first inter-RAT measurement portion 510-1 by a certain overlap time 508. During the overlap time 508, the shared RF resource of the wireless communication device may tune to first subscription 502 and perform the paging wake-up 506, which means that the first inter-RAT measurement portion 510-1 is interrupted and not performed.

To compensate for the time lost due to the paging wake-up 506, the wireless communication device may extend the end of the inter-RAT measurement 510 by a third inter-RAT measurement portion 510-3, as illustrated in FIG. 5B. The time duration of the third inter-RAT measurement portion 510-3 may be (at least) equal to the overlap time 508 (i.e., the same time duration as the first inter-RAT measurement portion 510-1 that was interrupted). For example, if the network allocated duration of the inter-RAT measurement 510 is 40 ms, and the paging wake-up 506 overlaps with the inter-RAT measurement 510 by 15 ms (i.e., the overlap time 508 is 15 ms), the time duration of the third inter-RAT measurement portion 510-3 added to the end of the inter-RAT measurement 510 may be 15 ms. The sum of the time duration of the third inter-RAT measurement portion 510-3 (i.e., the overlap time 508) and the second inter-RAT measurement portion 510-2 may equal the network allocated duration of 40 ms. This gives the second subscription 504 enough time to complete the inter-RAT measurement 510 even though the measurement is interrupted by the paging wake-up 506.

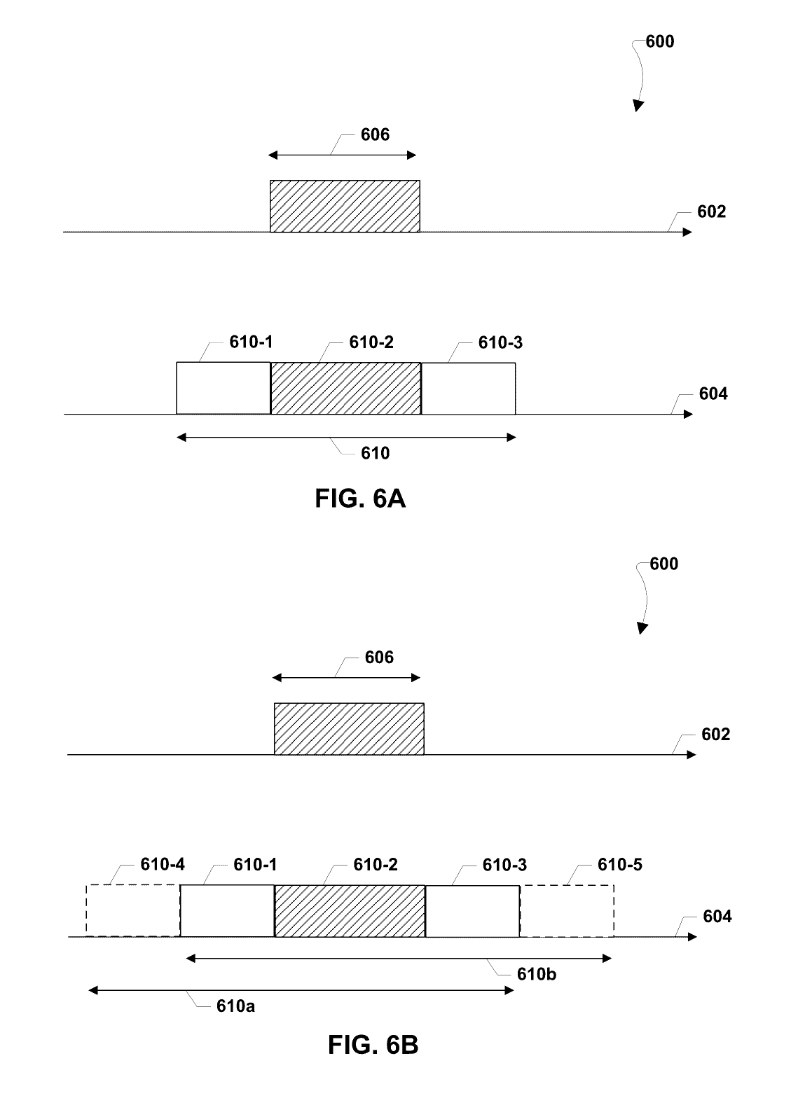

FIG. 6A includes a timing diagram 600 that illustrates a collision between a paging wake-up 606 on a first subscription 602 and an inter-RAT measurement 610 on a second subscription 604 of an MSMS wireless communication device. With reference to FIGS. 1-6B, the inter-RAT measurement 610 may be divided into a first inter-RAT measurement portion 610-1, a second inter-RAT measurement portion 610-2, and a third inter-RAT measurement portion 610-3. In the example illustrated in FIG. 6A, the inter-RAT measurement 610 begins before the paging wake-up 606, and ends after the end of the paging wake-up 606 (i.e., the paging wake-up 606 occurs entirely within the span of the inter-RAT measurement 610). In this example, the paging wake-up 606 overlaps with the second inter-RAT measurement portion 610-2. During the overlap time, the shared RF resource of the wireless communication device may tune to first subscription 602 and perform the paging wake-up 606, which means that the second inter-RAT measurement portion 610-2 is interrupted and not performed. The non-overlapping portions of the inter-RAT measurement 610 (the first inter-RAT measurement portion 610-1 and the third inter-RAT measurement portion 610-3) may still be performed.

To compensate for the time lost due to the paging wake-up 606, the wireless communication device may determine the time duration of the first inter-RAT measurement portion 610-1 (i.e., P amount of time) and the time duration of the third inter-RAT measurement portion 610-3 (i.e., Q amount of time). The wireless communication device may then determine the time duration that is greater (i.e., whether P is greater than Q). If the time duration of the first inter-RAT measurement portion 610-1 is greater than the time duration of the third inter-RAT measurement portion 610-3 (i.e., P>Q), the wireless communication device may extend the beginning of the inter-RAT measurement 610 by a fourth inter-RAT measurement portion 610-4, resulting in inter-RAT measurement 610a. The time duration of the fourth inter-RAT measurement portion 610-4 may be (at least) equal to the network allocated time of the inter-RAT measurement 610 minus the time duration of the first inter-RAT measurement portion 610-1 (i.e., the beginning non-overlapping time). For example, if the network allocated time of the inter-RAT measurement 610 is 40 ms, the time duration of the first inter-RAT measurement portion 610-1 is 15 ms (i.e., P=15 ms), and the time duration of the third inter-RAT measurement portion 610-3 is 10 ms (i.e., Q=10 ms), the time duration of the fourth inter-RAT measurement portion 610-4 may be 25 ms (i.e., 40 ms-15 ms). This gives the second subscription 604 enough time to complete the inter-RAT measurement 610a even though the measurement is interrupted by the paging wake-up 606.

If the time duration of the third inter-RAT measurement portion 610-3 is greater or equal to the time duration of the first inter-RAT measurement portion 610-1 (i.e., P≦Q), the wireless communication device may extend the end of the inter-RAT measurement 610 by a fifth inter-RAT measurement portion 610-5, resulting in inter-RAT measurement 610b. The time duration of the fifth inter-RAT measurement portion 610-5 may be (at least) equal to the network allocated time of the inter-RAT measurement 610 minus the time duration of the third inter-RAT measurement portion 610-3 (i.e., the end non-overlapping time). For example, if the network allocated time of the inter-RAT measurement 610 is 40 ms, the time duration of the first inter-RAT measurement portion 610-1 is 10 ms (i.e., P=10 ms), and the time duration of the third inter-RAT measurement portion 610-3 is 15 ms (i.e., Q=15 ms), the time duration of the fifth inter-RAT measurement portion 610-5 may be 25 ms (i.e., 40 ms-15 ms). This gives the second subscription 604 enough time to complete the inter-RAT measurement 610b even though the measurement is interrupted by the paging wake-up 606.

In alternative embodiments, if the time duration of the first inter-RAT measurement portion 610-1 is greater than the time duration of the third inter-RAT measurement portion 610-3 (i.e., P>Q), the wireless communication device may extend the end of the inter-RAT measurement 610 by the fifth inter-RAT measurement portion 610-5, in which the duration of the fifth inter-RAT measurement portions 610-5 is (at least) equal to the duration of the second inter-RAT measurement portion 610-2 (i.e., extend the end of the inter-BRAT measurement 610 by the overlapping time of by the paging wake-up 606). If the time duration of the third inter-RAT measurement portion 610-3 is greater than or equal to the time duration of the first inter-RAT measurement portion 610-1 (i.e., P≦Q), the wireless communication device may extend the beginning of the inter-RAT measurement 610 by the fourth inter-RAT measurement portion 610-4, in which the duration of the fourth inter-RAT measurement portions 610-4 is (at least) equal to the duration of the second inter-RAT measurement portion 610-2 (i.e., extend the beginning of the inter-BRAT measurement 610 by the overlapping time of by the paging wake-up 606).

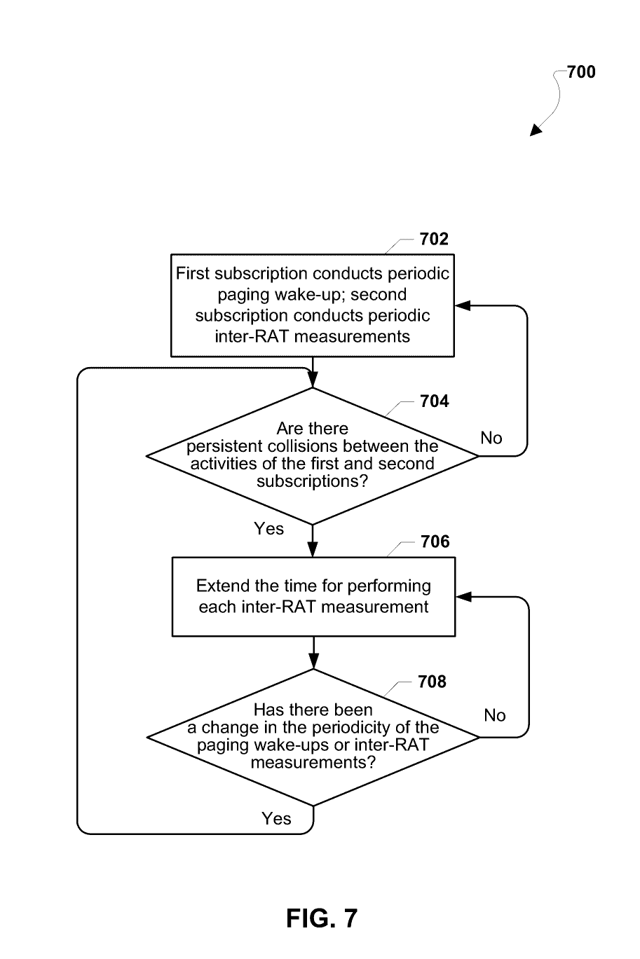

FIG. 7 illustrates a method 700 for handling collisions between a first subscription and a second subscription of a wireless communication device according to various embodiments. With reference to FIGS. 1-7, the operations of the method 700 may be implemented by one or more processors of the multi-SIM communication device 200, such as a general purpose processor 206, a baseband modem processor(s) 216, or a separate controller (not shown) that may be coupled to the memory 214 and to the baseband modem processor(s) 216. For example, the physical layer of the baseband modem processor 216 may implement the method 700 by checking the scheduled activities (e.g., paging wake-ups, inter-RAT measurements) on the radio link control (RLC) layer and adjusting the scheduling of activities. The wireless communication device may be a MSMS device, for example a DSDS device with a first subscription (e.g., TD-SCDMA, LTE) and a second subscription (e.g., GSM, CDMA, WCDMA) sharing an RF resource.

In block 702, the first subscription on the wireless communication device may be idle and conducting periodic paging (e.g., PICH) wake-ups. The period and the duration of the paging wake-ups may be determined by the network base station on which the first subscription is camped. For example, the paging wake-ups may be performed every 640 ms and have a duration of 17 ms. The second subscription on the wireless communication device may also be idle and conducting periodic inter-RAT measurements (e.g., DMO gaps). The period and the duration of the inter-RAT measurements may be determined by the network base station on which the second subscription is camped. For example, the inter-RAT measurements may be performed every 640 ms and have a duration of 40 ms. The inter-RAT measurements may be performed to identify potential handovers on the second subscription to other RATs.

In determination block 704, the processor may determine whether there are persistent collisions (i.e., continual overlap over successive periods) occurring between the periodic paging wake-ups of the first subscription and the periodic inter-RAT measurements of the second subscription. For example, the processor may determine whether the paging wake-ups and the inter-RAT measurements have the same period. The processor may also monitor attempts to perform the inter-RAT measurements for a predetermined amount of time (e.g., a certain number of periods of the inter-RAT measurements). If the processor detects that the inter-RAT measurements attempted by the second subscription during the predetermined amount of time are not completed or are blocked, this may be an indication of a persistent collision.

In response to determining that there are no persistent collisions between the periodic paging wake-ups of the first subscription and the periodic inter-RAT measurements of the second subscription (i.e., determination block 704=“No”), the processor may continue to conduct paging wake-ups on the first subscription and inter-RAT measurements on the second subscription in block 702 and monitor for persistent collisions in determination block 704.

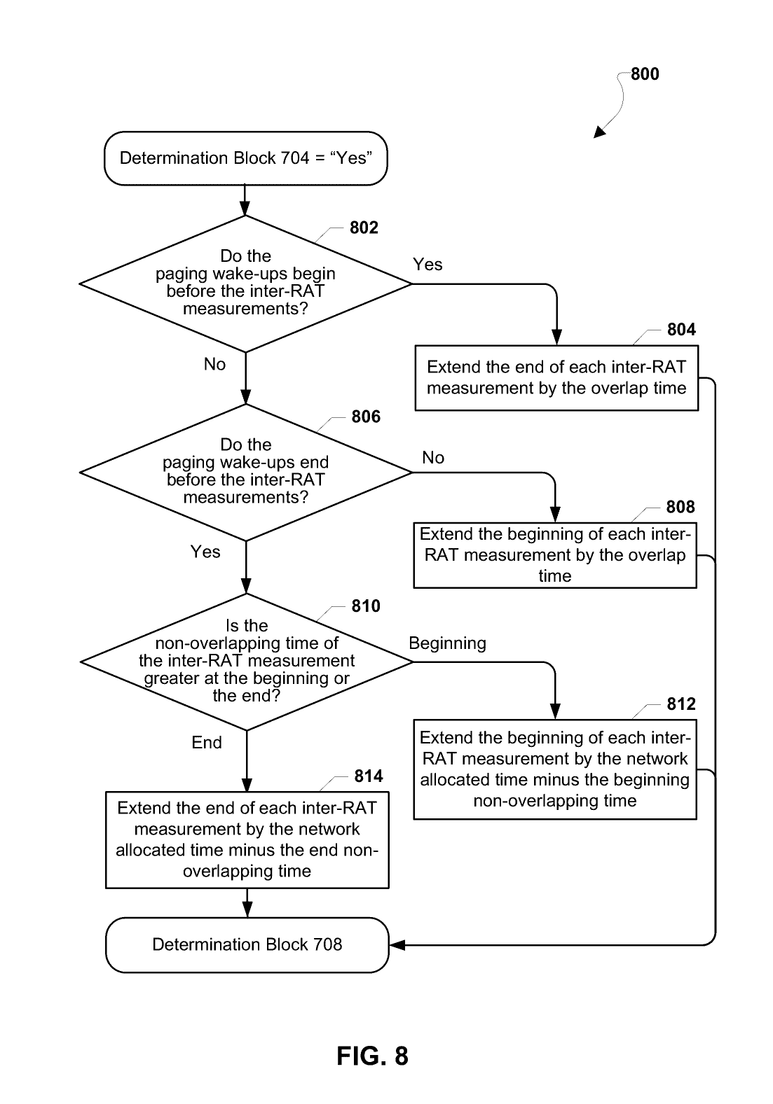

In response to determining that there are persistent collisions between the periodic paging wake-ups of the first subscription and the periodic inter-RAT measurements of the second subscription (i.e., determination block 704=“Yes”), the processor may extend the time for performing each inter-RAT measurement on the second subscription in block 706. Extending the time of the inter-RAT measurements may allow the second subscription to complete the inter-RAT measurements even in the presence of the paging wake-up interruptions. The extension of time may depend on the amount of overlap between the paging wake-ups and the inter-RAT measurements, and the relative timing between the paging wake-ups and the inter-RAT measurements (e.g., depending on whether one begins before the other). Various methods for extending the time of the inter-RAT measurements are described in further detail with reference to method 800 (FIG. 8).

In determination block 708, the processor may determine whether there has been a change in the periodicity of the paging wake-ups on the first subscription or the periodicity of the inter-RAT measurements on the second subscription. For example, the length of the periods or the relative timing between the periods may change if either the first subscription or the second subscription performs a handover to another network cell. The new cell may assign a different period to either the paging wake-ups or the inter-RAT measurements, or the relative timing between the paging wake-ups or the inter-RAT measurements may change.

In response to determining that there has been no change in the periodicity of the paging wake-ups on the first subscription or the periodicity of the inter-RAT measurements on the second subscription (i.e., determination block 708=“No”), the processor may continue to extend the time for performing each inter-RAT measurement in block 706.

In response to determining that there has been a change in the periodicity of the paging wake-ups on the first subscription or the periodicity of the inter-RAT measurements on the second subscription (i.e., determination block 708=“Yes”), the processor may determine whether there are persistent collisions between the periodic paging wake-ups of the first subscription and the periodic inter-RAT measurements of the second subscription given the change in periodicity in determination block 704. In this manner, the method 700 provides a way to complete inter-RAT measurements in the presence of paging wake-up interruptions by extending the time to perform each inter-RAT measurement.

FIG. 8 illustrates a method 800 for extending the time to perform inter-RAT measurements on a wireless communication device according to various embodiments. With reference to FIGS. 1-8, the operations of the method 800 may be implemented by one or more processors of the multi-SIM communication device 200, such as a general purpose processor 206, a baseband modem processor(s) 216, or a separate controller (not shown) that may be coupled to the memory 214 and to the baseband modem processor(s) 216. For example, the physical layer of the baseband modem processor 216 may implement the method 800 by checking the scheduled activities (e.g., paging wake-ups, inter-RAT measurements) on the radio link control (RLC) layer and adjusting the scheduling of activities. The wireless communication device may be a MSMS device, for example a DSDS device with a first subscription (e.g., TD-SCDMA, LTE) and a second subscription (e.g., GSM, CDMA, WCDMA) sharing an RF resource.

The method 800 may implement the operations represented by block 706 to extend the time for performing inter-RAT measurements on a second subscription in the presence of paging wake-up interruptions on a first subscription. Thus, in response to determining that there are persistent collisions between the periodic paging wake-ups of the first subscription and the periodic inter-RAT measurements of the second subscription (i.e., determination block 704=“Yes”), the processor may determine whether the paging wake-ups begin before the inter-RAT measurements in determination block 802.

In response to determining that the paging wake-ups begin before the inter-RAT measurements (i.e., determination block 802=“Yes”), the processor may extend the end of each inter-RAT measurement by the overlap time between the paging wake-ups and the inter-RAT measurements in block 804. For example, if the overlap time between the paging wake-ups and the inter-RAT measurements is 10 ms, then the end of each inter-RAT measurement may be extended by 10 ms.

In response to determining that the paging wake-ups do not begin before the inter-RAT measurements (i.e., determination block 802=“Yes”), the processor may determine whether the paging wake-ups end before the inter-RAT measurements in determination block 806. That is, upon determining that the inter-RAT measurements begin before the paging wake-ups, the processor may determine whether the paging wake-ups end before the end of the inter-RAT measurements (i.e., the paging wake-ups occur entirely within the span of the inter-RAT measurements), or whether the paging wake-ups end after the end of the inter-RAT measurements.

In response to determining that the paging wake-ups do not end before the inter-RAT measurements (i.e., determination block 806=“No”), the processor may extend the beginning of each inter-RAT measurement by the overlap time between the paging wake-ups and the inter-RAT measurements in block 808. For example, if the overlap time between the paging wake-ups and the inter-RAT measurements is 10 ms, then the beginning of each inter-RAT measurement may be extended by 10 ms.

In response to determining that the paging wake-ups end before the inter-RAT measurements (i.e., determination block 806=“Yes”), the processor may determine whether the beginning non-overlapping time period of the inter-RAT measurements is greater than the end non-overlapping time period of the inter-RAT measurements in determination block 810. That is, upon determining that the paging wake-ups occur entirely within the span of the inter-RAT measurements, the processor may determine whether the non-overlapping beginning or end portions of the inter-RAT measurements are greater. For example, the processor may determine a first non-overlapping time period between the beginning of the inter-RAT measurements and the beginning of the paging wake-ups, and a second non-overlapping time period between the end of the paging wake-ups and the end of the inter-RAT measurements, and then determine which non-overlapping time period is greater.

In response to determining that the beginning non-overlapping time period of the inter-RAT measurements is greater than the end non-overlapping time period of the inter-RAT measurements (i.e., determination block 810=“Beginning”), the processor may extend the beginning of each inter-RAT measurement by a time that is equal to the network allocated time for the inter-RAT measurement minus the beginning non-overlapping time period in block 812. For example, if the network allocated time for the inter-RAT measurement is 40 ms and the paging wake-ups begin 15 ms after the start of the inter-RAT measurements (i.e., 15 ms of beginning non-overlapping time), then the beginning of each inter-RAT measurement may be extended by 25 ms (40 ms-15 ms).

In response to determining that the beginning non-overlapping time period of the inter-RAT measurements is not greater than the end non-overlapping time period of the inter-RAT measurements (i.e., determination block 810=“End”), the processor may extend the end of each inter-RAT measurement by a time that is equal to the network allocated time for the inter-RAT measurement minus the end non-overlapping time period in block 814. For example, if the network allocated time for the inter-RAT measurement is 40 ms and the paging wake-ups end 15 ms before the end of the inter-RAT measurements (i.e., 15 ms of end non-overlapping time), then the end of each inter-RAT measurement may be extended by 25 ms (40 ms-15 ms).

After extending the time for performing each inter-RAT measurement in blocks 804, 808, 812, or 814, the processor may determine whether there has been a change in the periodicity of the paging wake-ups on the first subscription or the periodicity of the inter-RAT measurements on the second subscription in determination block 708. In this manner, the method 800 provides various ways to extend the time for performing inter-RAT measurements on a subscription in the presence of paging wake-up interrupts on another subscription.

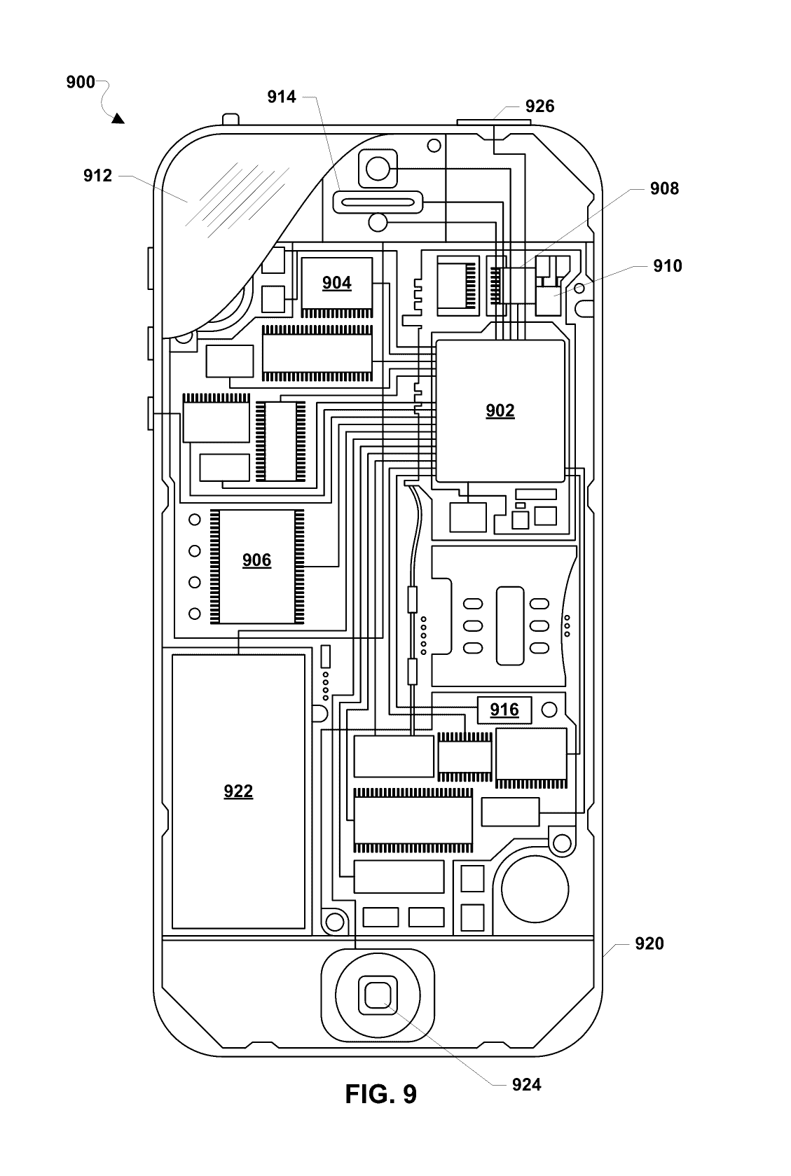

Various embodiments may be implemented in any of a variety of wireless communication devices, an example of which (e.g., wireless communication device 900) is illustrated in FIG. 9. According to various embodiments, the wireless communication device 900 may be similar to the wireless communication devices 110, 120 as described with reference to FIG. 1, as well as multi-SIM communication device 200 as described with reference to FIG. 2. As such, the wireless communication device 900 may implement the methods 700 and 800 in FIGS. 7-8.

With reference to FIGS. 1-9, the wireless communication device 900 may include a processor 902 coupled to a touchscreen controller 904 and an internal memory 906. The processor 902 may be one or more multi-core integrated circuits designated for general or specific processing tasks. The internal memory 906 may be volatile or non-volatile memory, and may also be secure and/or encrypted memory, or unsecure and/or unencrypted memory, or any combination thereof. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the wireless communication device 900 need not have touch screen capability.

The wireless communication device 900 may have one or more cellular network transceivers 908 coupled to the processor 902 and to one or more antennas 910 and configured for sending and receiving cellular communications. The one or more transceivers 908 and the one or more antennas 910 may be used with the herein-mentioned circuitry to implement methods according to various embodiments. The wireless communication device 900 may include one or more SIM cards 916 coupled to the one or more transceivers 908 and/or the processor 902 and may be configured as described herein.

The wireless communication device 900 may also include speakers 914 for providing audio outputs. The wireless communication device 900 may also include a housing 920, constructed of a plastic, metal, or a combination of materials, for containing all or some of the components discussed herein. The wireless communication device 900 may include a power source 922 coupled to the processor 902, such as a disposable or rechargeable battery. The rechargeable battery may also be coupled to the peripheral device connection port to receive a charging current from a source external to the wireless communication device 900. The wireless communication device 900 may also include a physical button 924 for receiving user inputs. The wireless communication device 900 may also include a power button 926 for turning the wireless communication device 900 on and off.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit various embodiments to a particular order, sequence, type of network or carrier.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, compact disc read only memory (CD-ROM) or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc in which disks usually reproduce data magnetically, while discs reproduce data optically with lasers. Combinations of the storage media are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for handling collisions between a first subscription and a second subscription of a wireless communication device, comprising:
determining whether there are persistent collisions between periodic paging wake-ups on the first subscription and periodic inter-radio access technology (RAT) measurements on the second subscription; and
extending a time for performing each inter-RAT measurement on the second subscription in response to determining that there are persistent collisions between periodic paging wake-ups on the first subscription and periodic inter-RAT measurements on the second subscription.

2. The method of claim 1, wherein determining whether there are persistent collisions between periodic paging wake-ups on the first subscription and periodic inter-RAT measurements on the second subscription comprises monitoring inter-RAT measurement attempts on the second subscription for a predetermined time period.

3. The method of claim 2, wherein the predetermined time period comprises a number of inter-RAT measurement periods.

4. The method of claim 1, wherein extending the time for performing each inter-RAT measurement on the second subscription comprises:
determining whether the paging wake-ups begin before the inter-RAT measurements; and
extending an end of each inter-RAT measurement by an overlap time between the inter-RAT measurements and the paging wake-ups in response to determining that the paging wake-ups begin before the inter-RAT measurements.

5. The method of claim 1, wherein extending the time for performing each inter-RAT measurement on the second subscription comprises:
determining whether the paging wake-ups end before the inter-RAT measurements end; and
extending a beginning of each inter-RAT measurement by an overlap time between the inter-RAT measurements and the paging wake-ups in response to determining that the paging wake-ups do not end before the inter-RAT measurements end.

6. The method of claim 1, wherein extending the time for performing each inter-RAT measurement on the second subscription comprises:
determining whether the paging wake-ups end before the inter-RAT measurements end; and
in response to determining that the paging wake-ups end before the inter-RAT measurements end:
determining a first non-overlapping time period between a beginning of the inter-RAT measurements and a beginning of the paging wake-ups;
determining a second non-overlapping time period between an end of the paging wake-ups and an end of the inter-RAT measurements; and
determining whether the first non-overlapping time period is greater than the second non-overlapping time period.

7. The method of claim 6, further comprising:
extending the beginning of each inter-RAT measurement by a time equal to an network allocated time to perform each inter-RAT measurement minus the first non-overlapping time period in response to determining that the first non-overlapping time period is greater than the second non-overlapping time period; and
extending the end of each inter-RAT measurement by a time equal to the network allocated time to perform each inter-RAT measurement minus the second non-overlapping time period in response to determining that the first non-overlapping time period is not greater than the second non-overlapping time period.

8. The method of claim 1, further comprising:
determining whether there has been a change in periodicity of the paging wake-ups or a change in periodicity of the inter-RAT measurements; and
determining whether there are persistent collisions between the periodic paging wake-ups on the first subscription and the periodic inter-RAT measurements on the second subscription in response to determining that there has been a change in the periodicity of the paging wake-ups or a change in the periodicity of the inter-RAT measurements.

9. A wireless communication device, comprising:
a radio frequency (RF) resource; and
a processor coupled to the RF resource, configured to connect to a first subscriber identity module (SIM) associated with a first subscription and to a second SIM associated with a second subscription, and configured with processor-executable instructions to:
determine whether there are persistent collisions between periodic paging wake-ups on the first subscription and periodic inter-radio access technology (RAT) measurements on the second subscription; and
extend a time for performing each inter-RAT measurement on the second subscription in response to determining that there are persistent collisions between periodic paging wake-ups on the first subscription and periodic inter-RAT measurements on the second subscription.

10. The wireless communication device of claim 9, wherein the processor is further configured with processor-executable instructions to determine whether there are persistent collisions between periodic paging wake-ups on the first subscription and periodic inter-RAT measurements on the second subscription by monitoring inter-RAT measurement attempts on the second subscription for a predetermined time period.

11. The wireless communication device of claim 10, wherein the predetermined time period comprises a number of inter-RAT measurement periods.

12. The wireless communication device of claim 9, wherein the processor is further configured with processor-executable instructions to extend the time for performing each inter-RAT measurement on the second subscription by:
determining whether the paging wake-ups begin before the inter-RAT measurements; and
extending an end of each inter-RAT measurement by an overlap time between the inter-RAT measurements and the paging wake-ups in response to determining that the paging wake-ups begin before the inter-RAT measurements.

13. The wireless communication device of claim 9, wherein the processor is further configured with processor-executable instructions to extend the time for performing each inter-RAT measurement on the second subscription by:
determining whether paging wake-ups end before the inter-RAT measurements end; and
extending a beginning of each inter-RAT measurement by an overlap time between the inter-RAT measurements and the paging wake-ups in response to determining that the paging wake-ups do not end before the inter-RAT measurements end.

14. The wireless communication device of claim 9, wherein the processor is further configured with processor-executable instructions to extend the time for performing each inter-RAT measurement on the second subscription by:
determining whether the paging wake-ups end before the inter-RAT measurements end; and
in response to determining that the paging wake-ups end before the inter-RAT measurements end:
determining a first non-overlapping time period between a beginning of the inter-RAT measurements and a beginning of the paging wake-ups;
determining a second non-overlapping time period between an end of the paging wake-ups and an end of the inter-RAT measurements; and
determining whether the first non-overlapping time period is greater than the second non-overlapping time period.

15. The wireless communication device of claim 14, wherein the processor is further configured with processor-executable instructions to:
extend the beginning of each inter-RAT measurement by a time equal to an network allocated time to perform each inter-RAT measurement minus the first non-overlapping time period in response to determining that the first non-overlapping time period is greater than the second non-overlapping time period; and
extend the end of each inter-RAT measurement by a time equal to the network allocated time to perform each inter-RAT measurement minus the second non-overlapping time period in response to determining that the first non-overlapping time period is not greater than the second non-overlapping time period.

16. The wireless communication device of claim 9, wherein the processor is further configured with processor-executable instructions to:
determine whether there has been a change in periodicity of the paging wake-ups or a change in periodicity of the inter-RAT measurements; and
determine whether there are persistent collisions between the periodic paging wake-ups on the first subscription and the periodic inter-RAT measurements on the second subscription in response to determining that there has been a change in the periodicity of the paging wake-ups or a change in the periodicity of the inter-RAT measurements.

17. A non-transitory computer readable storage medium having stored thereon processor-executable software instructions configured to cause a processor of a wireless communication device to perform operations comprising:
determining whether there are persistent collisions between periodic paging wake-ups on a first subscription of the wireless communication device and periodic inter-radio access technology (RAT) measurements on a second subscription of the wireless communication device; and
extending a time for performing each inter-RAT measurement on the second subscription in response to determining that there are persistent collisions between periodic paging wake-ups on the first subscription and periodic inter-RAT measurements on the second subscription.

18. The non-transitory computer readable storage medium of claim 17, wherein the stored processor-executable software instructions are configured to cause the processor of the wireless communication device to perform operations such that determining whether there are persistent collisions between periodic paging wake-ups on the first subscription and periodic inter-RAT measurements on the second subscription comprises monitoring inter-RAT measurement attempts on the second subscription for a predetermined time period.

19. The non-transitory computer readable storage medium of claim 18, wherein the predetermined time period comprises a number of inter-RAT measurement periods.

20. The non-transitory computer readable storage medium of claim 17, wherein the stored processor-executable software instructions are configured to cause the processor of the wireless communication device to perform operations such that extending the time for performing each inter-RAT measurement on the second subscription comprises:
determining whether the paging wake-ups begin before the inter-RAT measurements; and
extending an end of each inter-RAT measurement by an overlap time between the inter-RAT measurements and the paging wake-ups in response to determining that the paging wake-ups begin before the inter-RAT measurements.

21. The non-transitory computer readable storage medium of claim 17, wherein the stored processor-executable software instructions are configured to cause the processor of the wireless communication device to perform operations such that extending the time for performing each inter-RAT measurement on the second subscription comprises:
determining whether the paging wake-ups end before the inter-RAT measurements end; and
extending a beginning of each inter-RAT measurement by an overlap time between the inter-RAT measurements and the paging wake-ups in response to determining that the paging wake-ups do not end before the inter-RAT measurements end.

22. The non-transitory computer readable storage medium of claim 17, wherein the stored processor-executable software instructions are configured to cause the processor of the wireless communication device to perform operations such that extending the time for performing each inter-RAT measurement on the second subscription comprises:
determining whether the paging wake-ups end before the inter-RAT measurements end; and
in response to determining that the paging wake-ups end before the inter-RAT measurements end:
determining a first non-overlapping time period between a beginning of the inter-RAT measurements and a beginning of the paging wake-ups;
determining a second non-overlapping time period between an end of paging wake-ups and an end of the inter-RAT measurements; and
determining whether the first non-overlapping time period is greater than the second non-overlapping time period.

23. The non-transitory computer readable storage medium of claim 22, wherein the stored processor-executable software instructions are configured to cause the processor of the wireless communication device to perform operations further comprising:
extending the beginning of each inter-RAT measurement by a time equal to an network allocated time to perform each inter-RAT measurement minus the first non-overlapping time period in response to determining that the first non-overlapping time period is greater than the second non-overlapping time period; and
extending the end of each inter-RAT measurement by a time equal to the network allocated time to perform each inter-RAT measurement minus the second non-overlapping time period in response to determining that the first non-overlapping time period is not greater than the second non-overlapping time period.

24. The non-transitory computer readable storage medium of claim 17, wherein the stored processor-executable software instructions are configured to cause the processor of the wireless communication device to perform operations further comprising:
determining whether there has been a change in periodicity of the paging wake-ups or a change in periodicity of the inter-RAT measurements; and
determining whether there are persistent collisions between the periodic paging wake-ups on the first subscription and the periodic inter-RAT measurements on the second subscription in response to determining that there has been a change in the periodicity of the paging wake-ups or a change in the periodicity of the inter-RAT measurements.

25. A wireless communication device, comprising:
means for determining whether there are persistent collisions between periodic paging wake-ups on a first subscription of the wireless communication device and periodic inter-radio access technology (RAT) measurements on a second subscription of the wireless communication device; and
means for extending a time for performing each inter-RAT measurement on the second subscription in response to determining that there are persistent collisions between periodic paging wake-ups on the first subscription and periodic inter-RAT measurements on the second subscription.
